(19) United States
(12) Patent Application Publication
(10) Pub. No.: US 2016/0082512 A1
(43) Pub. Date: Mar. 24, 2016

(54) SINTER PASTE WITH PARTIALLY OXIDIZED METAL PARTICLES

(71) Applicant: HERAEUS DEUTSCHLAND GMBH & CO. KG, Hanau (DE)

(72) Inventors: Michael SCHÄFER, Künzell (DE); Wolfgang SCHMITT, Rodgau (DE)

(21) Appl. No.: 14/888,777

(22) PCT Filed: Apr. 30, 2014
(86) PCT No.: PCT/EP2014/058891

§ 371 Date: Nov. 3, 2015

(30) Foreign Application Priority Data
May 3, 2013 (EP) 13002360.9

(51) Int. Cl. B22F 9/02; B23K 35/30; B23K 1/00; B23K 35/36; B23K 1/19; B23K 35/28; B23K 35/02

(52) U.S. Cl. CPC B22F 9/02; B23K 35/286; B23K 35/3006; B23K 35/3033; B23K 35/302; B23K 35/025; B23K 35/3613; B23K 35/3612; B23K 1/19; B23K 1/00; B23K 2203/12

(57) ABSTRACT

A sinterable mixture and method of producing the mixture are provided containing: (a) metal particles and (b) an organic compound represented by Formula I: R¹—COR² (I), wherein R¹ is an aliphatic residue having 8 to 32 carbon atoms, and R² comprises either an —OM moiety or an —X—R³ moiety, wherein M is a cation, wherein X is selected from the group consisting of O, S, N—R⁴, and wherein R³ is a hydrogen atom or an aliphatic residue and R⁴ is a hydrogen atom or an aliphatic residue, wherein a molar ratio of carbon present in the organic compound (b) to oxygen present in the metal particles (a) is in a range of 3 to 50. The mixture is used for connecting components in a sandwich arrangement with the mixture in between and sintering the sandwich arrangement.

### CROSS-REFERENCE TO RELATED APPLICATIONS

This application is a Section 371 of International Application No. PCT/EP2014/058891, filed Apr. 30, 2014, which was published in the German language on Nov. 6, 2014, under International Publication No. WO 2014/177645 A1 and the disclosure of which is incorporated herein by reference.

### BACKGROUND OF THE INVENTION

The invention relates to a sinterable mixture, and to a method for the connecting of components, in which the mixture is used. Moreover, the invention relates to a method for producing the sinterable mixture.

In power electronics, the connecting of components, such as LEDs or very thin silicon chips, comprising high pressure and temperature resistance, is particularly challenging. For this reason, the pressure- and temperature-sensitive components are often connected to each other by gluing. However, adhesive technology is associated with a disadvantage in that it produces contact sites between the components that comprise only insufficient heat conductivity and/or electrical conductivity. In order to solve this problem, the components to be connected are often subjected to sintering. Sintering technology is a very simple method for the connecting of components in stable manner and utilizes sinter pastes.

For example, U.S. Pat. No. 7,766,218 describes the use of sinter pastes containing silver particles that are coated, at least in part, with fatty acids or fatty acid derivatives and a volatile dispersion agent for improving the sintering process and the electrical and thermal conductivity.

International patent application publication WO 2011/026624 A1 discloses sinter pastes containing metal particles, metal precursors, solvents, and sintering aids.

According to European patent application publication EP 2 425 290 A, at least one aliphatic hydrocarbon compound is added to the sinter pastes in order to ensure a low sintering temperature.

However, it has been evident that continues to be a need to improve the sinterability of customary pastes or mixtures, in particular at low process pressures, despite the use of various sintering aids.

In the scope of the invention, sinterability comprises the ability of the metal particles-containing mixture to diffuse as well as the bonding of the contacts the mixture was used to connect.

Moreover, there continues to be a need for sinterable mixtures that can be used in a broader temperature and pressure range than is feasible at this time. Moreover, it would be desirable to have sinterable mixtures that comprise improved diffusability and whose use under comparable conditions leads to improved bonding of the sintered contacts as compared to previously customary pastes.

### BRIEF SUMMARY OF THE INVENTION

The invention is therefore based on the object to provide a sinterable mixture, in particular a sinter paste, which possesses improved sinterability, in particular when applied to a copper surface. It is another object of the invention to provide a sinterable mixture that allows the sintering process to proceed at milder conditions, mainly at lower temperatures and lower pressures, than is allowed according to the prior art. Accordingly, the use of the mixture needs to be an energy saving method for the connecting of contacts.

The object is met through the features of the invention described and claimed herein.

Accordingly, a subject matter of the invention is a mixture containing
a) metal particles and
b) an organic compound represented by Formula I: R¹—COR² (I), wherein R¹ is an aliphatic residue having 8 to 32 carbon atoms, and R² comprises either the —OM moiety or the —X—R³ moiety, wherein M is a cation and wherein X is selected from the group consisting of O, S, N—R⁴, and wherein R³ is a hydrogen atom or an aliphatic residue, and R⁴ is a hydrogen atom or an aliphatic residue,
wherein the molar ratio of carbon present in organic compound (b) to oxygen present in metal particles (a) is in the range of 3 to 50.

Moreover, the invention relates to a method for the connecting of at least two components, comprising providing a sandwich arrangement that comprises at least a first component, a second component, and the mixture according to the invention, wherein the mixture is situated between the first and second component, and sintering of the sandwich arrangement.

The mixtures of the invention can be sintered and are present, preferably, as sinter pastes, in particular as printable sinter pastes.

The invention is based on the surprising finding that the molar ratio of carbon in organic compound b) to oxygen in metal particles a) has a significant influence on the sinterability of the mixtures produced from them. It has been found, surprisingly, that only a relatively narrow range of ratios leads to improved sintering properties.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:
FIG. 1 is a schematic side elevation view showing a bending test of a silicon component sintered to a substrate according to an embodiment of the invention; and
FIG. 2 is a schematic side elevation view showing a comparative bending test of a silicon component sintered to a substrate with poor results.

### DETAILED DESCRIPTION OF THE INVENTION

### Metal Particles (a)

The mixture according to the invention contains metal particles.

In the scope of the invention, the term, “metal” refers to an element in the periodic system of the elements that is in the same period as boron, but to the left of boron, in the same period as silicon, but to the left of silicon, in the same period as germanium, but to the left of germanium, and in the same period as antimony, but to the left of antimony, as well as all elements having an atomic number of more than 55. According to the invention, the term, “metal” also includes alloys and inter-metallic phases.

The purity of the metal preferably is at least 95% by weight, more preferably at least 98% by weight, even more preferably at least 99% by weight, and yet more preferably at least 99.9% by weight.

In the scope of the invention, metal particles also include metal particles that are partially oxidized, for example are surface-oxidized.

According to a preferred embodiment, the metal is selected from the group consisting of copper, silver, nickel, and aluminum as well as from alloys and mixtures thereof. According to a particularly preferred embodiment, the metal is silver.

In another preferred embodiment, at least one metal of the metal particles (a) is selected from the group consisting of silver, copper, and mixtures thereof.

The metals of the metal particles (a) preferably consist essentially of silver or copper or mixtures of copper and silver.

In this context, “essentially” shall mean that at least 95% by weight and specifically at least 97.5% by weight of the metal particles (a) consist of the corresponding metal or mixture of metals.

According to the invention, metal alloys shall be understood to be metallic mixtures of at least two components of which at least one is a metal.

According to a preferred embodiment, the scope of the invention involves using an alloy containing copper, aluminum, nickel and/or precious metals as metal alloy. The metal alloy preferably comprises at least one metal selected from the group consisting of copper, silver, gold, nickel, palladium, platinum, and aluminum. Particularly preferred metal alloys contain at least two metals selected from the group consisting of copper, silver, gold, nickel, palladium, platinum, and aluminum. Moreover, it can be preferred that the fraction of metals selected from the group consisting of copper, silver, gold, nickel, palladium, platinum, and aluminum accounts for at least 90% by weight, preferably at least 95% by weight, more preferably at least 99% by weight, and even more preferably 100% by weight of the metal alloy. The alloy can be, for example, an alloy that contains copper and silver, copper, silver and gold, copper and gold, silver and gold, silver and palladium, platinum and palladium or nickel and palladium.

The metal particles according to the scope of the invention can just as well be particles consisting of multiple phases. Accordingly, the metal particles can comprise, for example, a core made of at least one metallic phase that is coated with at least one further metallic phase. Silver-coated copper particles shall be mentioned for exemplary purposes in this context as they are included in the definition of metal particles according to the invention. Moreover, the metal coating can just as well be applied to a non-metallic core.

In an alternative embodiment, the metal particles comprise two or more different metals.

Also preferred are metal particles comprising a metal core made of a non-precious metal and a coating made of a precious metal, e.g. silver-coated copper particles.

The mixture according to the invention can contain, as metal, a pure metal, multiple types of pure metals, a type of metal alloy, multiple types of metal alloys or mixtures thereof. The metal is present in the mixture in the form of particles.

The metal particles can differ in shape. The metal particles can be present, for example, in the form of flakes or be of a spherical (ball-shaped) shape. According to a particularly preferred embodiment, the metal particles take the shape of flakes. However, this does not exclude a minor fraction of the particles employed being of different shape. However, preferably at least 70% by weight, more preferably at least 80% by weight, even more preferably at least 90% by weight or 100% by weight, of the particles are present in the form of flakes.

The metal particles present in the mixture according to the invention can be homogeneous or heterogeneous in terms of their composition. In particular, the mixture can contain particles made of different metals.

The mixture according to the invention preferably contains 60-99.7% by weight, more preferably 77-89% by weight, and even more preferably 80-88% by weight metal particles, relative to the total weight of the mixture. For sinterable mixtures according to the invention, the amount of metal particles a) can be in the range of 96-99.7% by weight, preferably 96.5-99.5% by weight, more preferably 97-99.3% by weight, and in particular in the range of 97.5-99.0% by weight, each relative to the total weight of metal particles a) and organic compound b).

Preferably, the metal particles are partially oxidized. Alternatively, mixtures made of metal particles can be present, wherein a part of the particles is non-oxidized and a part of the particles is partially or fully oxidized.

The oxygen content of metal particles (a) in the mixture according to the invention preferably is in the range of 0.01 to 0.15% by weight, in particular between 0.05 and 0.10% by weight relative to the total weight of the metal particles.

The determination of the oxygen content of the metal particles can be done, for example, according to analytical procedures known to a person skilled in the art by hot extraction of carrier gas using the TC 436 analyzer from Leco (USA), wherein the oxygen content is determined indirectly through conversion to CO₂, wherein the CO₂ gas is detected by a CO₂ infrared measuring cell. The determination of the oxygen content can be based on the ASTM E1019-03 standard. The conditioning of the device for ensuring that the measurements are reproducible is done by gas calibration with a known amount of CO₂ gas and by testing certified steel standards of Leco, whose oxygen content is approximately on the order of magnitude of the expected oxygen content of the sample to be tested. For sample preparation, 100 to 150 mg of the metal powder are weighed into a tin capsule of Leco. The sample and the tin capsule are then placed into a graphite crucible of Leco at 2,000° C., which had been purged twice before-hand for approximately 30 seconds each at 2,500° C. The oxygen of the sample reacts with the carbon of the graphite to form carbon monoxide (CO). The latter, in turn, is oxidized on a copper oxide column (Cu(II)O) from Leco to form carbon dioxide (CO₂), wherein the column has a device-specific temperature of approximately 600° C. The CO₂ thus generated is detected by an infra-red cell and the oxygen content of the sample is determined accordingly. The blank value of an unfilled tin capsule needs to be determined under the same conditions before the actual measurement on the sample is performed. The device subtracts this blank value from the measured value (tin capsule and sample) during the actual measurement.

Organic Compound (b)

Moreover, the sinter paste of the invention contains an organic compound that is represented by Formula I: R¹COR² (I), wherein R¹ is an aliphatic residue having 8 to 32, preferably 10-24, particularly preferably 12 to 18, carbon atoms and can be branched or non-branched. In addition, R¹ can contain hetero atoms. R² comprises either the —OM moiety or the —X—R³ moiety, wherein M is a cation and wherein X is selected from the group consisting of O, S, and N—R⁴, wherein R³ is a hydrogen atom or an aliphatic residue, and R⁴ is a hydrogen atom or an aliphatic residue. In this context, X is preferred to be O, N or S, particularly preferably O.

Preferably R³ and/or R⁴ is/are an aliphatic residue having 1 to 32, more preferably 10 to 24, and in particular 12 to 18, carbon atoms, wherein the residue can be linear or branched. Moreover, the residue can comprise, in addition, one or more hetero atoms. The aliphatic residue can be saturated or unsaturated.

The organic compound preferably is a compound selected from the group consisting of fatty acids (X═O and R³═H), fatty acid salts (M═cation), and fatty acid esters.

The free fatty acids, fatty acid salts, and fatty acid esters preferably are non-branched.

Moreover, the free fatty acids, fatty acid salts, and fatty acid esters preferably are saturated.

According to a preferred embodiment, the organic compound is a fatty mono-acid, a salt of a fatty mono-acid or a fatty mono-acid ester.

In a preferred embodiment, organic compound (b) is a C₈-C₃₀ fatty acid, preferably a C₈-C₂₄ fatty acid, in particular a C₁₂-C₁₈ fatty acid.

Conceivable fatty acid salts are preferably salts whose anionic component is the deprotonated fatty acid and whose cationic component M is selected from the group consisting of ammonium ions, monoalkylammonium ions, dialkylammonium ions, trialkylammonium ions, lithium ions, sodium ions, potassium ions, copper ions, and aluminum ions.

Preferred fatty acid esters are derived from the corresponding fatty acids, wherein methyl, ethyl, propyl or butyl esters are preferred.

According to a preferred embodiment, the organic compound is selected from the group consisting of caprylic acid (octanoic acid), capric acid (decanoic acid), lauric acid (dodecanoic acid), myristic acid (tetradecanoic acid), palmitic acid (hexadecanoic acid), stearic acid (octadecanoic acid), mixtures thereof, as well as the corresponding esters and salts, and mixtures thereof.

According to a particularly preferred embodiment, the organic compound is selected from the group consisting of lauric acid (dodecanoic acid), stearic acid (octadecanoic acid), sodium stearate, potassium stearate, aluminum stearate, copper stearate, sodium palmitate, potassium palmitate, and any mixtures thereof.

Moreover, organic compound (b) is preferably selected from the group consisting of octanoic acid, stearic acid, lauric acid, palmitic acid, and any mixtures thereof.

For example a mixture of lauric acid and stearic acid is a particularly preferred mixture. Preferred mixtures have a weight ratio of stearic acid to lauric acid above 1:1.

Preferably, organic compound (b) is present in the form of a coating on the metal particles (a).

The term, coating of particles, shall be understood to refer to a firmly adhering layer on the surface of particles. A firmly adhering layer shall be understood to mean that the layer does not detach from the metal particles simply by the effect of gravity.

The metal particles used in this context are commercially available. The corresponding organic compounds can be applied to the surface of the metal particles by conventional methods that are known from the prior art.

It is feasible, for example, to slurry the organic compound, in particular the stearic acid and/or lauric acid mentioned above, in solvents and to triturate it together with the metal particles in ball mills. After trituration, the coated metal particles are dried and then dust is removed.

Preferably, the fraction of organic compounds (b), in particular the fraction of compounds selected from the group consisting of free fatty acids, fatty acid salts or fatty acid esters that preferably comprise 8 to 24, more preferably 10 to 24, and even more preferably 12 to 18 carbon atoms, of the entire coating is at least 60% by weight, more preferably at least 70% by weight, even more preferably at least 80% by weight, yet more preferably at least 90% by weight, in particular at least 95% by weight, at least 99% by weight or 100% by weight.

According to a preferred embodiment, the content of organic compound (b) is 0.1 to 4.0% by weight, more preferably between 0.3 and 3.0% by weight, particularly between 0.4 and 2.5% by weight, in particular between 0.5% by weight to 2.2% by weight, and specifically between 0.8 and 2.1% by weight, relative to the total weight of particles (a) and compound (b).

The degree of coating, defined as the ratio of the mass of organic compound (b) to the surface of the metal particles (a), preferably is 0.003 to 0.03 g, more preferably 0.007 to 0.02 g, and even more preferably 0.01 to 0.015 g of organic compound per square metre (m²) of surface of the metal particles.

According to a preferred embodiment, the mixture according to the invention contains 0.05 to 3.5% by weight or 0.08 to 2.5% by weight, more preferably 0.25 to 2.2% by weight, and even more preferably 0.5 to 2% by weight of organic compound (b), which preferably is selected from the group consisting of fatty acids, fatty acid salts, and fatty acid esters, each relative to the total weight of the mixture according to the invention.

In a preferred embodiment, the molar ratio of carbon contained in organic compound (b) and oxygen contained in the metal particles is in the range of 4 to 45, preferably of 5 to 40, more preferably of 10 to 35, in particular of 12 to 30, and specifically of 15 to 25 or in the range of 12 to 45, with 15 to 14 being preferred.

It has been found, surprisingly, that establishing a certain molar ratio of carbon contained in organic compound (b) and oxygen contained in the metal particles allows the sinterability of the pastes to be improved, which is expressed in improved strength of the components connected to each other by sintering. In this context, the ratio, at which the improvement of the sinterability can be observed, is in the range of 3 to 50, preferably of 4 to 45. If the ratio is outside of the specified range, no improvement of the sinterability can be obtained. Likewise, an excessive content of organic compound (b) has a negative effect on the application properties of the mixture.

The carbon content of the organic compound (b) can be calculated from the added amount of organic compound (b). Alternatively, the carbon content can also be determined analytically by methods known to a person skilled in the art, such as elemental analysis, for examples in accordance with the ASTM D 529102 standard. The carbon content of organic compound (b) present in the mixture can be determined, for example, by first removing all carbon-containing compounds of the mixture according to the invention with the exception of organic compound (b) from the mixture and by then determining the carbon content of the remaining mixture (e.g. by elemental analysis). The carbon-containing compounds can also be removed, for example, by heating the mixture for a sufficient period of time to a temperature below the boiling point of organic compound (b), but above the boiling point of all other carbon-containing compounds of the mixture.

Presumably, carbon monoxide is released during the sintering process. Carbon monoxide is a reducing agent and as such is capable of reducing the metal oxide present on the surface of the metal particles. Removing the metal oxide ensures unimpeded diffusion and ensuing increase in the diffusion rate. The reduction of the metal oxide is also associated with the generation of in situ reactive metal that further favors the sintering process. Moreover, the reactive metal can fill voids between the metal atoms of the metal particles during the sintering process and can thus significantly decrease the porosity of the contact site of the two components to be connected. As a result, extremely stable and heat-conductive as well as electrically conductive contact sites are being generated.

### Dispersing Agent (c)

The sinterable mixtures according to the invention can be present as sinter pastes and then usually contain an additional dispersing agent (c). The dispersing agents that are common for metal pastes are conceivable for the sinter pastes.

Accordingly, the sinterable mixture of a preferred embodiment of the invention contains an additional dispersing agent (c).

In the scope of the invention, dispersing agent shall be understood to mean substances that can dissolve or disperse other substances through physical processes.

According to the invention, the dispersing agents that are common for metal pastes are conceivable. Preferably, organic compounds having at least one hetero atom and 6 -24 carbon atoms, more preferably 8 -20 carbon atoms, specifically 8 to 14 carbon atoms, are used as dispersing agent.

The organic compounds can be branched or non-branched. Dispersing agents (c) preferably are cyclic compounds, in particular cyclic and unsaturated compounds.

Moreover, the organic compounds used as dispersing agent can be saturated, mono-unsaturated or multi-unsaturated compounds.

The at least one hetero atom contained in the organic compounds that can serve as solvent is preferably selected from the group consisting of oxygen atoms and nitrogen atoms.

The at least one hetero atom can be part of at least one functional group.

According to a particularly preferred embodiment, the dispersing agent used in this context is an alcohol.

Monocyclic mono-terpene alcohols, such as, for example, terpineol, in particular α-terpineol, are specifically preferred.

It is particularly preferred for the boiling point of the dispersing agent to be below the temperature used for sintering the pastes. It is specifically preferred for the boiling temperature of the dispersing agent to be below 240° C., more preferably below 230° C., in particular below 220° C.

For example, α-terpineol ((R)-(+)-α-terpineol, (S)-(−)-α-terpineol or racemates), β-terpineol, γ-terpineol, δ-terpineol, mixtures of the preceding terpineols, N-methyl-2-pyrrolidone, ethylene glycol, dimethylacetamide, 1-tridecanol, 2-tridecanol, 3-tridecanol, 4-tridecanol, 5-tridecanol, 6-tridecanol, isotridecanol, dibasic esters (preferably dimethylesters of glutaric, adipic or succinic acid or mixtures thereof), glycerol, diethylene glycol, triethylene glycol or mixtures thereof can be used in this context.

According to a preferred embodiment, it is preferred to use aliphatic hydrocarbon compounds as dispersing agent. In this context, the aliphatic hydrocarbons can consist of saturated compounds, mono- or multiply-unsaturated compounds, and mixtures thereof. Preferably, the aliphatic hydrocarbon compounds consist of saturated hydrocarbon compounds, wherein these can be cyclic or acyclic, such as, for example, n-alkanes, isoalkanes, cycloalkanes or mixtures thereof. The aliphatic hydrocarbon compounds can, for example, be represented by the formulas, CₙH₂ₙ₊₂, CₙH₂ₙ, and CₙH₂ₙ₋₂, wherein n is an integer between 5 and 32. In a particularly preferred embodiment, the aliphatic hydrocarbon compounds that can be used as dispersing agent are selected from the group consisting of hexadecane, octadecane, isohexadecanes, isooctadecanes, cyclohexadecanes, and cyclooctadecanes.

Dispersing agent (c) differs from organic compound (b), in particular dispersing agent (c) is not an organic compound included in the definition of organic compound (b).

The dispersing agent usually is present in an amount of 6 to 40% by weight, preferably 8 to 25% by weight, specifically 10 to 20% by weight, each relative to the total weight of the mixture according to the invention.

The type and amount of dispersing agent can be used to adjust the flow properties of the sinter pastes. Sinter pastes are preferably applied by printing methods to the components to be sintered.

### Polymers Comprising Oxygen Atoms (Component (d))

It has also been found, surprisingly, that the addition of organic polymers comprising oxygen atoms further increases the sinterability.

Therefore, the mixture according to the invention comprises a polymer comprising oxygen atoms in a preferred embodiment. A polymer, in which the oxygen present is bound as ether and/or hydroxide, is particularly preferred. Also preferred is a polymer that comprises alkoxy groups, in particular ethoxylate and/or methoxylate groups.

For example, polysaccharides, such as, e.g., celluloses, which are preferably chemically modified, for example which have been alkoxylated or alkylcarboxylated, are suitable polymers.

The celluloses preferably comprise a degree of substitution of 2.0 to 2.9, more preferably between 2.2 and 2.8. The degree of substitution indicates the average number of chemically modified, in particular etherified, hydroxyl groups per glucose unit. Ethyl cellulose is specifically preferred. It preferably has an ethoxy content of 43.0% to 53.0%, particularly preferably of 47.5% to 50%, in particular of 48.0% to 49.5%, each relative to the number of hydroxyl groups, wherein the ethoxy content of a fully substituted cellulose would be 54.88%. Preferably, the viscosity of the cellulose is 60 to 120 cps, more preferably 90 to 115 cps, particularly preferably 85 to 110 cps. In this context, the viscosity was determined according to ASTM D914 on a mixture consisting of 80% by weight toluene and 20% by weight ethanol using a Hercules Horizontal Capillary Viscosimeter at 25° C.

Preferably, the cellulose is selected from the group consisting of methylcellulose, ethylcellulose, ethylmethylcellulose, carboxymethylcellulose, hydroxypropylmethylcellulose, hydroxyethylcellulose, hydroxyethylmethylcellulose, or mixtures thereof. Ethylcellulose is a particularly preferred cellulose.

The presence of ethylcellulose improves the sinterability of the paste even more through optimized conversion of the organic compound to carbon monoxide.

Preferably, the mixture according to the invention contains 0.05 to 2.0% by weight of the oxygen-containing polymer, in particular of the cellulose, relative to the total weight of the mixture, even more preferably 0.1 to 0.8, and particularly preferably 0.2 to 0.5% by weight.

### Further Ingredients

Moreover, the mixture according to the invention can contain further ingredients, such as customary surfactants, de-foaming agents, binding agents or viscosity-controlling agents. Preferably, the mixtures can contain wetting agents.

The further ingredients are usually added in an amount of up to 0.01% by weight, preferably from 0.001 to 0.01% by weight, each relative to the total weight of the mixture according to the invention.

Preferably, the mixture according to the invention comprises essentially no glass, in particular no glass frit. Glass-forming agents, such as lead oxide, bismuth oxide, alkali and alkaline earth oxide, tellurium oxide, and the like are typical ingredients of a glass frit.

In this context, essential shall mean that the mixture contains less than 2% by weight, preferably less than 1% by weight, more preferably less than 0.5% by weight, in particular less than 0.1% by weight, specifically less than 0.05% by weight, for example 0% by weight glass and/or glass frit, wherein the specified weights each are relative to the total weight of the mixture.

In a specific embodiment, the metal particles a) of the sinterable mixture according to the invention are silver particles. It has been evident, surprisingly, that optimal sinterability can be attained if the oxygen content of the silver relative to the organic compound (b) can be perfectly matched to each other (for example by selecting partially oxidized silver and/or mixtures of silver and silver oxide). In a preferred embodiment, the molar ratio of total oxygen present in the silver particles and organic compound (b) to silver is approx. 1.0 to approx. 3.5, preferably approx. 1.2 to approx. 3.0, and, in particular, approx. 2.0 to approx. 2.7.

Moreover, the molar ratio of total carbon present in organic compound (b) to silver is in the range of approx. 5 to approx. 20, more preferably of approx. 7 to approx. 16, and, in particular, of approx. 10 to approx. 15.

Moreover, good sinterability results can be attained, if the composition of the mixture according to the invention is selected appropriately such that the molar ratio of carbon present in organic compound (b) to total oxygen present in metal particles (a), in particular in the silver particles, and organic compound (b) is adjusted appropriately to be in the range of approx. 200 to approx. 600, more preferably in the range of approx. 400 to approx. 570, and, in particular, in the range of approx. 500 to approx. 550.

In a preferred embodiment, the mixture according to the invention contains
(a) 75 to 90% by weight metal particles, preferably selected from the group consisting of silver, copper, aluminum, and nickel, in particular of silver
(b) 0.05 to 3.0% by weight organic compound (b) that preferably is selected from the group consisting of fatty acids, fatty acid salts, and fatty acid esters, in particular fatty acids, and that further preferably is present as coating on the metal particles (a), and
(c) 6 to 30% by weight of a dispersing agent that preferably is selected from the group of alcohols, in particular from the terpineols, and
(d) if applicable, 0.05 to 1.0% by weight of a cellulose, in particular ethylcellulose, wherein the molar ratio of carbon contained in organic compound (b) to oxygen contained in metal particles (a) is in the range of 5 to 40, preferably in the range of 10 to 35, more preferably in the range of 12 to 30, and particularly preferably in the range of 15 to 25, wherein the specified weights each relate to the total weight of the sinterable mixture.

### Sintering

Also a subject matter of the invention is a method for producing the mixture according to the invention, wherein metal particles (a), organic compound (b), and, if applicable, the dispersing agent (c) are being mixed.

According to a preferred refinement of the invention, the mixing of metal particles (a) and organic compound (b) proceeds in that organic compound (b) is being slurried in solvents and is milled together with metal particles (a) in disintegration devices, in particular in bead mills. Subsequently, the coated metal particles can be dried and dust can be removed, if applicable, in a further step.

The sinterable mixture according to the invention can be produced in mixing apparatus and stirrers that are familiar to a person skilled in the art. In a preferred refinement of the production method according to the invention, the metal particles are coated with organic compound (b) in a first step.

The coated particles are mixed with a dispersing agent (c) in a subsequent step.

According to the invention, the pastes according to the invention are used in a sintering process.

Preferably, sintering shall be understood to mean connecting two or more components through heating without producing a liquid phase. Accordingly, the sintering proceeds as a diffusion process.

According to the invention, connecting at least two components shall be understood to mean attaching a first component on a second component. In this context, “on” simply means that a surface of the first component is connected to a surface of the second component regardless of the relative disposition of the two components or of the arrangement containing the at least two components.

In the scope of the invention, the term “component” is preferred to comprise single parts. Preferably, the single parts cannot be disassembled further.

A component in the scope of the invention can be any object regardless of its function. In this context, the terms of component, part, and substrate are considered to be synonymous in the scope of the invention.

According to specific embodiments, a component is an object that comprises at least one metal surface.

According to specific embodiments, the term, components, refers to parts that are used in high-performance electronics.

Accordingly, components can, for example, be diodes, LEDs (light-emitting diodes, lichtemittierende Dioden), DCB (direct copper bonded) substrates, lead frames, dies, IGBTs (insulated-gate bipolar transistors, Bipolartransistoren mit isolierter Gate-Elektrode), ICs (integrated circuits, integrierte Schaltungen), sensors, heat sink elements (preferably aluminum heat sink elements or copper heat sink elements) or other passive components (such as resistors, capacitors or coils). Preferably, the components can just as well be non-metallic components.

The components to be connected can be identical or different components.

Preferred embodiments of the invention relate to the connecting of LED to leadframe, of LED to ceramic substrate, of dies, diodes, IGBTs or ICs to leadframes, ceramic substrates or DCB substrates, of sensors to leadframe or ceramic substrate, of DCB or ceramic substrate to copper or aluminum heat sink elements, of leadframe to heat sink element or of tantalum capacitors, preferably in un-housed condition, to leadframe.

It is also preferred to connect more than two components to each other. For example, (i) LED or chip can be connected to (ii) leadframe and (iii) heat sink element, wherein the leadframe preferably is situated between (i) LED or chip and (iii) heat sink element. It is just as well to connect a diode to two heat sink elements, wherein the diode preferably is situated between two heat sink elements.

According to a preferred embodiment, the components can comprise at least one metal surface. The metal surface preferably is part of the component. Preferably, the metal surface is situated on at least one surface of the component.

The metal surface can comprise pure metal. Accordingly, it can be preferred for the metal surface to comprise at least 50% by weight, more preferably at least 70% by weight, even more preferably at least 90% by weight or 100% by weight of pure metal. Preferably, the pure metal is selected from the group consisting of aluminum, copper, silver, gold, palladium, and platinum.

On the other hand, the metal surface can just as well comprise an alloy. The alloy of the metal surface preferably contains at least one metal selected from the group consisting of silver, gold, nickel, palladium, and platinum. It can be preferred just as well that the alloy of the metal surface contains at least two metals selected from the group consisting of silver, gold, nickel, palladium, and platinum. The fraction of the alloy accounted for by the elements selected from the group consisting of silver, gold, nickel, palladium, and platinum preferably is at least 90% by weight, more preferably at least 95% by weight, even more preferably at least 99% by weight, for example 100% by weight.

According to a preferred embodiment, the metal surface preferably contains at least 95% by weight, more preferably at least 99% by weight, and even more preferably 100% by weight of the alloy. The metal surface can just as well have a multi-layer structure. Accordingly, it can be preferred that at least one surface of the components to be connected comprises a metal surface made of multiple layers that comprise the pure metals and/or alloys specified above.

According to a preferred embodiment, at least one metal surface of a component, in particular of a DCB substrate, comprises a layer made of copper onto which a layer made of nickel is applied. If applicable, yet another layer made of gold can be applied onto the layer made of nickel. In this case, the thickness of the layer made of nickel preferably is 1-2 μm and the thickness of the layer made of gold preferably is 0.05-0.3 μm. On the other hand, it can just as well be preferred to have a metal surface of a component comprise a layer made of silver or gold and, above it, a layer made of palladium or platinum.

According to a further preferred embodiment, the individual layers also contain a glass in addition to the specified pure metals or alloys. It can be preferred just as well that the layers are a mixture of (i) glass and (ii) the pure metals or alloys.

According to the invention, at least two components are being connected to each other through sintering.

For this purpose, the at least two components are first made to contact each other. The contacting is effected by the metal paste according to the invention in this context. For this purpose, an arrangement is provided, in which metal paste is situated between each two of the at least two components.

Accordingly, if two components, i.e. component 1 and component 2, are to be connected to each other, the metal paste according to the invention is situated between component 1 and component 2 before the sintering process. On the other hand, it is conceivable to connect more than two components to each other. For example three components, i.e. component 1, component 2, and component 3, can be connected to each other in appropriate manner such that component 2 is situated between component 1 and component 3. In this case, the metal paste according to the invention is situated both between component 1 and component 2 as well as between component 2 and component 3. The invention provides the individual components in a sandwich arrangement and provides them to get connected to each other.

According to the invention, “sandwich arrangement” shall be understood to mean an arrangement, in which two components are situated one above the other and in which the contact surfaces to be connected are situated essentially parallel with respect to each other.

A further aspect of the invention is a method for connecting at least two components that comprises the following step of:
providing a sandwich arrangement that comprises at least a first component, a second component, and a mixture according to the invention, wherein the mixture is situated between the first and the second component, and
sintering the sandwich arrangement.

The arrangement of at least two components and metal paste, wherein the metal paste is situated between two components of the arrangement, can be produced according to any method known according to the prior art.

Preferably, firstly, at least one surface of a component 1 is provided with the metal paste according to the invention. Then, another component 2 is placed by one of its surfaces on the metal paste that has been applied to the surface of component 1.

According to a preferred embodiment of the method, at least one of the components possesses a metal surface, preferably a gold surface, palladium surface, silver surface or copper surface onto which the mixture according to the invention is being applied.

An embodiment of the method comprising the following steps is also preferred:
(a) applying a mixture according to the invention to a component surface of a component;
(b) providing a sandwich arrangement by arranging a second component appropriately such that the mixture is situated between the first component and the second component; and
(c) sintering the sandwich arrangement.

An embodiment, in which at least one of the component surfaces onto which the mixture is being applied, is a non-precious metal surface, in particular copper, is particularly preferred.

It has been evident, surprisingly, that a mixture according to the invention, in which the molar ratio of carbon contained in organic compound (b) to oxygen contained in metal particles (a) is in the range of 11 to 48, specifically 14 to 40, is advantageous, in particular if one of the component surfaces to be connected comprises a non-precious metal surface, in particular copper. It has also been evident that sintering at a low process pressure, for example 0 MPa, is feasible in particular at this molar ratio.

The application of the metal paste to the surface of a component can be effected through any conventional method. Preferably, the metal paste is applied by printing methods, for example by screen printing or stencil printing. However, the metal paste can be applied just as well by dispensing technology, by spraying technology, by jet technology, by pin transfer or by immersion.

It is preferable, following the application of the metal paste, to contact the surface of the component that has been provided with the metal paste to a surface of the component to be connected thereto by the metal paste. Accordingly, a layer of the metal paste is situated between the components to be connected.

Preferably, the thickness of the wet layer between the components to be connected is in the range of 15-200 μm. In this context, thickness of the wet layer shall be understood to mean the distance between the opposite surfaces of the components to be connected prior to the sintering process. The preferred thickness of the wet layer depends on the method selected for applying the metal paste. If the metal paste is applied, for example, by a screen printing method, the thickness of the wet layer can preferably be 15-50 μm. If the metal paste is applied by stencil printing, the preferred thickness of the wet layer can be in the range of 50-200 μm. According to a preferred embodiment, a drying step is performed prior to the sintering process.

Preferably, drying shall be understood to mean reducing the dispersing agent fraction in the metal paste.

The drying can proceed either after producing the arrangement, i.e. after contacting the components to be connected. However, the drying can just as well proceed right after application of the metal paste onto the at least one surface of the component and before contacting to the component to be connected.

Preferably, the drying temperature is in a range of 50-160° C.

Obviously, the drying time depends on the specific composition of the metal paste and the size of the arrangement to be sintered. Common drying times are in the range of 5-45 minutes.

The arrangement consisting of the at least two components and metal paste situated between the components is finally subjected to a sintering process.

In this context, the dimensions of the components can preferably very from approx. 0.5 mm² to 180 cm², wherein preferred components are rectangular or circular.

The sintering process preferably proceeds at a temperature of 180° C. or less and 250° C. or less, in particular at 200° C. or more and 240° C. or less.

In this context, the process pressure preferably is in the range of 30 MPa or less and 0 MPa or more, more preferably in the range of 5 MPa or more and 25 MPa or less. However, the sintering process can also be implemented without applying any process pressure, i.e. at a process pressure of 0 MPa. The sintering time depends on the process pressure and preferably is in the range of 2-60 minutes.

The sintering process can proceed in an atmosphere that is not subject to any limitations. However, preferably the sintering process is carried out in an atmosphere that contains oxygen.

The sintering process takes place in a conventional suitable apparatus for sintering, in which the above-mentioned process parameters can preferably be set.

The invention is illustrated through the examples specified in the following, though these may not be construed such as to limit the invention in any way or form.

### EXAMPLES

### Production of the Metal Pastes

Initially, metal pastes 1-13 were produced by mixing the ingredients at the quantitative ratios given in Table 1.

A mixture of stearic acid and lauric acid at a mass ratio of 75:25 was used as the coating.

Partially-oxidized silver particles (D50:4 μm) were used as metal particles.

α-Terpineol or a 1:1 mixture of α-Terpineol and tridecanol was used as dispersing agent.

In Examples 6, 8, and 10, additional cellulose (degree of substitution: 100) was added to the paste.

### Application of the Paste, and Sintering Procedure

The paste was applied by stencil printing at 20° C. to 25° C., wherein the stencil was 75 μm in thickness and the printed area was 10×10 mm. A steel squeegee with a pitch angle of 60° was used. The printing speed was 50 mm/s.

The metal pastes produced were used to sinter two components that were to be connected to each other.

The sinterability (see Table 2) of different sinterable mixtures (Table 1) was determined by two sintering procedures, i.e. pressure sintering and pressure-free sintering. The sintering conditions are described in the following:
(a) Pressure sintering
The pressure sintering proceeded after application of the sinter paste to a component that comprised a gold/nickel surface, with the sinter paste in contact with the gold side, or a copper surface. Subsequently, the sinter paste was contacted to a silicon component bearing a TiNiAg metallization and sintered at the respective pressure (process pressure) at 240° C. for 3 minutes.
(b) Pressure-free sintering

The pressure-free sintering proceeded after application of the sinter paste to a component that comprised a gold/nickel surface (with the sinter paste in contact with the gold side) or a copper surface.
Subsequently, the sinter paste was contacted to a silicon component bearing a TiNi-Ag metallization.
The following heating profile was used in pressure-free sintering: The contact site to be sintered was heated steadily over the course of 30 minutes from 25° C. to 160° C. and then maintained at 160° C. for 30 minutes. Subsequently, the temperature was raised steadily to a final temperature of 230° C. over the course of 5 minutes and then maintained at this level for 60 minutes. Subsequently, the temperature was decreased steadily to 30° C. over the course of 50 minutes.

The sintering process can proceed in a protective gas atmosphere (nitrogen) or exposed to air.

### Evaluation of Sinterability

The sinterability was determined by two equally-weighted evaluation criteria:

First Criterion: Screen-Cutting Test

The sintered contact site had five parallel cut lines in horizontal and vertical direction. The distance between each of the cut lines was 1 mm.

A very good screen cut (grade=1) is evident, if the sinter layer does not detach and the cuts our clean.

A moderate screen cut (grade=3) is evident, if there is minor flaking and fracturing.

A very poor screen cut (grade=5) is evident, if the sinter layer detaches.

A good screen cut (grade=2) is evident, if the screen cut is between a very good and a moderate screen cut.

A poor screen cut (grade=4) is evident, if the screen cut is between a moderate and a very poor screen cut.

Second Criterion: Bending Test

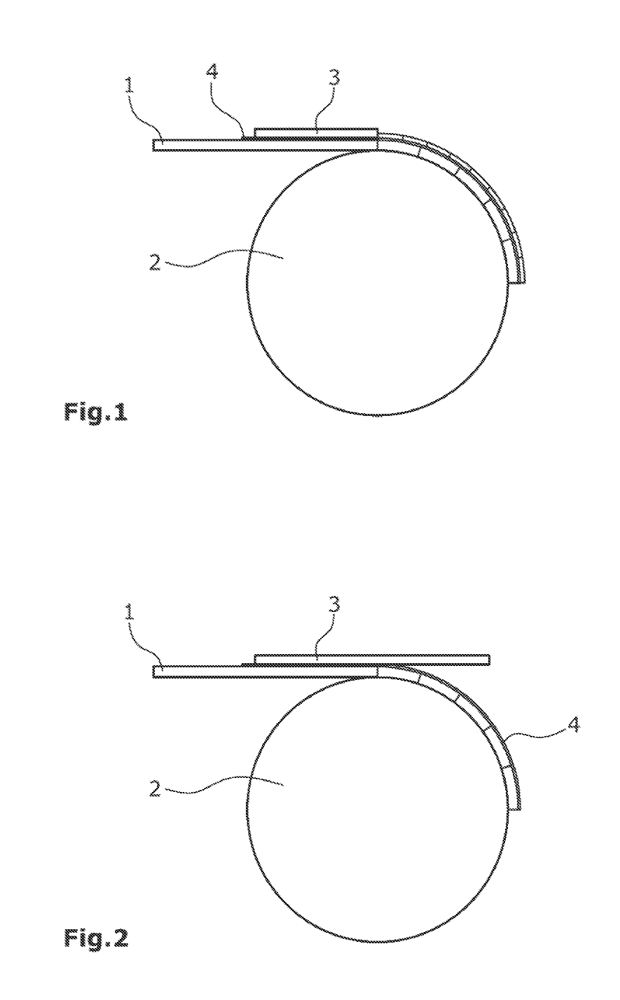

The substrate connected to the silicon component was attached on a roller as shown in FIGS. 1 and 2: In FIGS. 1 and 2, the silicon component (3), which is sintered to the substrate (nickel/gold component or copper component) (1) by the sinter layer (4), is attached on a roller (2) with a diameter of 2 cm. The composite was bent over the roller proceeding from right to left. FIG. 1 shows a bending test with a very good result (grade=1), since the silicon component (3) remains fully adherent to the substrate.

FIG. 2 shows a bending test with a very poor result (grade=5), since the silicon component (3) is being peeled from the substrate. Grades 2-4 are between these extremes.

Subsequently, the grades from the screen-cutting test and the bending test were added and the mean was calculated. The mean is shown as “Sinterability” in Table 2 for the respective sinterable mixtures.

The sinterability results of the individual pastes are shown in Table 2.

TABLE 1
Sinterable mixtures

| | 1 | 2 | 3 | 4 | 5 | 6 | 7 | 8 | 9 | 10 | 11 | 12 | 13 |
|---|---|---|---|---|---|---|---|---|---|---|---|---|---|
| Ag powder | 83 | 83 | 83 | 83 | 86 | 85 | 83 | 85 | 83 | 85 | 83 | 83 | 83 |
| (with coating) | | | | | | | | | | | | | |
| Coating content | 0.00 | 0.3 | 0.4 | 0.82 | 0.82 | 0.82 | 1.60 | 1.60 | 2.10 | 2.10 | 3.00 | 4.00 | 5.00 |
| α-Terpineol | 17 | 17 | 17 | 17 | 7 | 7.45 | 17 | 7.45 | 17 | 7.45 | 17 | 17 | 17 |
| Tridecanol | 0 | 0 | 0 | 0 | 7 | 7.3 | 0 | 0 | 7.3 | 0 | 7.3 | 0 | 0 |
| Ethylcellulose | 0 | 0 | 0 | 0 | 0 | 0.25 | 0 | 0.25 | 0 | 0.25 | 0 | 0 | 0 |
| Mole ratio C:O | 0 | 3.6 | 4.8 | 10 | 10 | 10 | 19 | 19 | 25 | 25 | 36 | 47.5 | 59 |

The values in the line titled “Coating content” refer to % by weight of organic compound b) relative to the total weight of silver powder and organic compound b) (that is present as coating on the silver particles).

The numbers for the coated silver powder, α-terpineol, tridecanol, and ethylcellulose each referred to the total weight of the sinterable mixture.

TABLE 2
Sinterability

| | 1 | 2 | 3 | 4 | 5 | 6 | 7 | 8 | 9 | 10 | 11 | 12 | 13 |
|---|---|---|---|---|---|---|---|---|---|---|---|---|---|
| Pressure sintering (240° C., 3 min) | | | | | | | | | | | | | |
| 20 MPa, Au/Ni surface, Au on top | 5 | 3.5 | 2 | 1 | 1 | 1 | 1 | 1.5 | 1.5 | 2 | 3 | 5 | 5 |
| 10 MPa, Au/Ni surface, Au on top | 5 | 4 | 3.5 | 3 | 4 | 1 | 1 | 1.5 | 1.5 | 2 | 2 | 4 | 5 |
| 10 MPa, Cu surface | 5 | 5 | 5 | 5 | 5 | 4 | 1 | 1 | 1.5 | 2.5 | 1 | 3 | 5 |
| Pressure-free sintering (230° C., 1 h) | | | | | | | | | | | | | |
| in air, Au/Ni surface, Au on top | 5 | 5 | 5 | 5 | 4 | 3.5 | 3 | 3 | 3.5 | 3.5 | 2.5 | 4 | 5 |
| in protective gas, Au/Ni surface, Au on top | 5 | 5 | 5 | 5 | 5 | 4 | 3 | 3 | 3.5 | 3.5 | 2 | 3.5 | 5 |
| in air, Cu surface | 5 | 5 | 5 | 5 | 5 | 5 | 3.5 | 3.5 | 4 | 4 | 2.5 | 3.5 | 5 |
| in protective gas, Cu surface | 5 | 5 | 5 | 5 | 5 | 5 | 2.5 | 2.5 | 3.5 | 3.5 | 1.5 | 3.5 | 5 |

Sinterability: 1 = very good, 2 = good, 3 = moderate, 4 = poor, 5 = very poor

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the invention as defined by the appended claims.

1.-19. (canceled)

20. A mixture containing
(a) metal particles and
(b) an organic compound represented by Formula I: R¹—COR² (I),
wherein R¹ is an aliphatic residue having 8 to 32 carbon atoms, and R² comprises either an —OM moiety or an —X—R³ moiety, wherein M is a cation,
wherein X is selected from the group consisting of O, S, N—R⁴, and wherein R³ is a hydrogen atom or an aliphatic residue and R⁴ is a hydrogen atom or an aliphatic residue,
wherein a molar ratio of carbon present in the organic compound (b) to oxygen present in the metal particles (a) is in a range of 3 to 50.

21. The mixture according to claim 20, wherein at least one metal of the metal particles (a) is selected from the group consisting of silver, copper, nickel, aluminum, and alloys and mixtures thereof.

22. The mixture according to claim 20, wherein at least one metal of the metal particles (a) is selected from the group consisting of silver, copper, and mixtures of copper and silver.

23. The mixture according to claim 20, wherein the organic compound (b) is a C₈-C₃₀ fatty acid, optionally a C₈-C₂₄ fatty acid or a C₁₂-C₁₈ fatty acid.

24. The mixture according to claim 20, wherein the organic compound (b) is selected from the group consisting of octanoic acid, stearic acid, lauric acid, palmitic acid, and any mixtures thereof.

25. The mixture according to claim 20, wherein the paste contains an additional polymer that comprises oxygen atoms.

26. The mixture according to claim 20 wherein the organic compound (b) is present in a form of a coating on the particles (a).

27. The mixture according to claim 20, wherein the organic compound (b) is present in an amount of 0.1 to 4.0% by weight, optionally between 0.3 and 3.0% by weight, between 0.4 and 2.5% by weight, between 0.5 and 2.2% by weight, or between 0.8 and 2.0% by weight, each relative to a total weight of the particles (a) and the organic compound (b).

28. The mixture according to claim 20, wherein the metal particles (a) have an oxygen content of 0.01 to 0.15% by weight, optionally 0.05 to 0.10% by weight, each relative to a weight of the metal particles (a).

29. The mixture according to claim 20, wherein the molar ratio of carbon contained in organic compound (b) to oxygen contained in the metal particles is in the range of 4 to 45, preferably of 5 to 40, more preferably of 10 to 35, in particular of 12 to 30, and specifically of 15 to 25 or in the range of 12 to 45, with 15 to 14 being preferred.

30. The mixture according to claim 20, additionally containing (c) a dispersing agent.

31. The mixture according to claim 30, wherein the dispersing agent (c) is selected from the group consisting of alpha-terpineol, beta-terpineol, gamma-terpineol, deltaterpineol, mixtures of the afore-mentioned terpineols, N-methyl-2-pyrrolidone, ethylene glycol, dimethylacetamide, 1-tridecanol, 2-tridecanol, 3-tridecanol, 4-tridecanol, 5-tridecanol, 6-tridecanol, isotridecanol, dibasic esters, preferably dimethylesters of glutaric, adipinic or succinic acid or mixtures thereof, glycerol, diethylene glycol, triethylene glycol, and mixture thereof.

32. A method for producing a mixture according to claim 20, wherein the metal particles (a), the organic compound (b), and an optional dispersing agent (c) are being mixed.

33. A method for connecting at least two components, the method comprising steps of:
providing a sandwich arrangement comprising at least a first component, a second component, and a mixture according to claim 20, wherein the mixture is situated between the first and the second components, and
sintering the sandwich arrangement.

34. The method according to claim 33, wherein the sintering step is implemented at a temperature of 180° C. to 250° C., optionally at 200° C. to 240° C.

35. The method according to claim 33, wherein the sintering step is implemented at a process pressure of 0 MPa to 30 MPa, optionally 5 MPa to 25 MPa.

36. The method according to claim 33, wherein at least one of the first and second components possesses a metal surface, optionally a gold surface, palladium surface, silver surface, or copper surface, onto which the mixture is applied.

37. The method according to claim 33, comprising steps of:
(a) applying a mixture onto a component surface of a first component;
(b) providing a sandwich arrangement by arranging a second component appropriately such that the mixture is situated between the first component and the second component; and
(c) sintering the sandwich arrangement.

38. The method according to claim 33, wherein at least one of the component surfaces onto which the mixture is applied is a non-precious metal surface, optionally copper.
